(19) United States
(12) Patent Application Publication
(10) Pub. No.: US 2007/0253069 A1
(43) Pub. Date: Nov. 1, 2007

(54) LENTICULAR CONTAINERS

(76) Inventor: Thomas K. Saville JR., Clovis, CA (US)

Correspondence Address: LUEDEKA, NEELY & GRAHAM, P.C., P O BOX 1871, KNOXVILLE, TN, 37901, US

(21) Appl. No.: 11/380,265

(22) Filed: Apr. 26, 2006

(51) Int. Cl. G02B 27/10

(52) U.S. Cl. 359/619

(57) ABSTRACT

A food safe cup, having a substantially continuous cup sidewall consisting essentially of a lenticular sheet made of a food safe material and an image formed of food safe ink applied directly to the lenticular sheet.

### FIELD

This invention relates to the field of containers having lenticular images. More particularly, this invention relates to simplified container structures having improved three-dimensional effects.

### BACKGROUND

Conventional lenticular containers, such as beverage cups, have at least two components: a printed lenticular sheet or multi-layer blank, and a beverage cup substrate to which the lenticular sheet/blank is affixed. The use of two components has caused a need for very thin lenticular lenses which limit the amount of visual three-dimensional perceived depth; a slow process of adhering the two substrates together; and an expensive product because of the duplicate materials and slow manufacturing time. Accordingly, improvement is desired in the manufacture of lenticular containers.

### SUMMARY

The above and other needs are met by containers of simplified construction provided in accordance with the disclosure. In one aspect, the disclosure describes containers having a substantially continuous container sidewall made of a lenticular sheet having a lens side and an opposite smooth side, and an image applied directly to the smooth side of the lenticular sheet.

In another aspect, the disclosure relates to a food safe cup, including a substantially continuous cup sidewall. The sidewall is provided by a lenticular sheet made of a food safe material and having a lens side and an opposite smooth side. An image formed of food safe ink is applied directly to the smooth side of the lenticular sheet.

In yet another aspect, the disclosure relates to a method of making a food safe container. The method includes the steps of providing a lenticular sheet made of a food safe material and having a lens side and an opposite smooth side; printing an image on the smooth side of the lenticular sheet using food safe ink; and forming the lenticular sheet into a container shape, wherein the smooth side of the lenticular sheet defines a substantially continuous interior sidewall of the container.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a perspective view of a cup made in accordance with a preferred embodiment of the disclosure.

FIG. 2 is a front plan view of a blank used to make the cup of FIG. 1.

FIG. 3 is a rear plan view of the blank of FIG. 2.

FIG. 4 is a cross-sectional side view of a lenticular sheet used to make the cup of FIG. 1.

FIG. 5 is a cross-sectional side view of the lenticular sheet having a food-safe coating applied thereto in accordance with an alternate embodiment of the disclosure.

### DETAILED DESCRIPTION

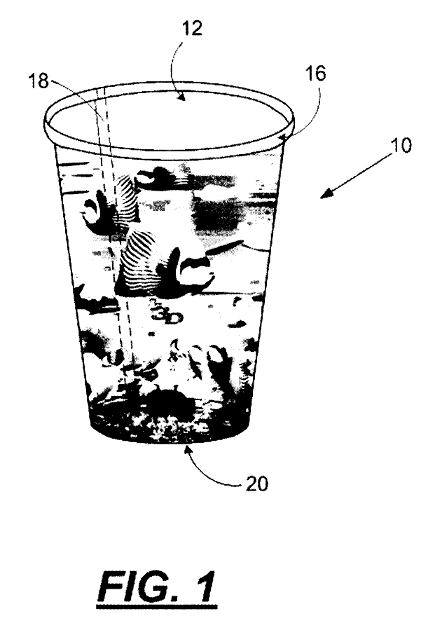

With reference to the drawings, the disclosure relates to simplified container structures having improved three-dimensional and other visual effects, and to the manufacture thereof. In a preferred embodiment, a cup 10 is provided (FIG. 1). The cup 10 is shown having a tapered wall design, but it will be understood that the cup could be otherwise configured, such as having a straight wall design. It will also be understood that the cup 10 is provided as an example of a preferred container and that containers of other configuration may be provided according to the disclosure, such as bowls, cones, ice cream and candy containers, and the like for retail packaging.

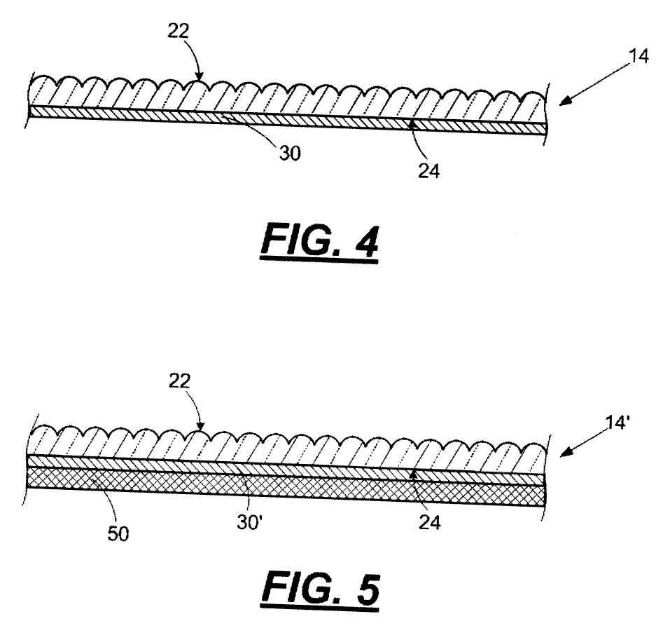

The cup 10 includes a continuous sidewall 12 made of a lenticular sheet 14 (FIG. 4). A first open end of the cup 10 preferably includes a lip 16 formed by an upper edge portion of the sheet 14 rolled upon itself. While it is preferred that the cup 10 include the lip 16 for improved strength characteristics, it will be understood that the end could also be straight and not include the lip 16. The ends of the sheet 14 are overlapped to define a longitudinal seam 18. A bottom member 20, preferably made of polypropylene and shaped as a disk, is secured to a bottom portion of the sidewall 12 to provide a cup bottom.

According to a preferred embodiment of the disclosure, the cup 10 is configured for holding consumable beverages, such as beer, soft drinks, tea, and the like. For such applications involving containment of consumables, the lenticular sheet 14 is preferably provided by a food-safe lenticular sheet or web having an image or other printing applied using food-safe inks. The term “food-safe,” as used herein, will be understood to mean that the material complies with the requirements of the Food and Drug Administration (FDA) as set forth in 21 CFR 177.1315 and 21 CFR 174. The sheet 14 has a lens side 22 and an opposite smooth side 24.

Preferred food-safe lenticular sheets are polypropylene lenticular sheets having a thickness of from about 0.008 to about 0.025 inches, most preferably from about 0.012 to about 0.20 inches, with a lens pattern ranging from about 50 to about 200 lens per inch, most preferably from about 75 to about 100 lens per inch. However, it will be understood that the lens pattern may be otherwise selected depending on the desired visual effect. Suitable lenticular sheets are conventional extruded polypropylene lenticular sheets available from Spartech Plastics in Sheboygan Falls, Wis. Embossed, cast, and other formed lenticular sheets may also be used. The lenticular material is described herein as being provided in sheet form, however, it will be understood that the lenticular material may also be provided in a web or roll form if desired.

It will be understood that the parameters of the lenses are not critical, with their selection corresponding to the desired graphic effect. However, it has been observed that containers provided in accordance with the present disclosure enable the use of lenticular materials of greater thickness than the lenticular materials used to make conventional cups incorporating lenticular materials. This advantageously enables improved graphic effects.

A pattern, graphic or other image 30 is printed using a suitable ink directly onto the smooth side 24 of the lenticular sheet 14. The printing may be accomplished as by conventional techniques such as lithographic, screen printing, ink jet printing, and the like. The printing may be done on individual sheets or on a roll depending on the manner the lenticular material is provided. Preferred food-safe inks include non-toxic inks available under the tradename NO-TOX from Colorcon, Inc. of West Point, Pa.

To facilitate the printing of the lenticular sheets 14, especially those made of polypropylene, the sheets are preferably treated using a corona treatment wherein an electrical discharge or “corona” is applied to the sheets to excite the surface atoms so that they are receptive to bonding with printing inks. Corona treatment may be accomplished in-line at the time of sheet extrusion, or off-line, or on the printing equipment. Corona treatment may be accomplished as by use of conventional corona discharge surface treatment equipment configured for treating plastic sheet materials, such as equipment available from Corotec Corporation of Farmington, Conn.

The image 30 may be a single image or graphic or preferably a plurality of images and graphics printed to provide a viewer with a three-dimensional effect or other multi-dimensional effect, such as a motion effect. This may be accomplished as by printing interlaced images, with the lens providing the dimensional effect. The interlaced images may be created as by use of commercially available graphics software, with a computerized printing process. The ink applied to provide the image 30 is preferably applied at a thickness of from about 0.001 to about 0.003 inches. The image 30 may preferably include a small amount of a white or similar colored food safe ink applied to provide a background for the image 30 in the manner of an opaque or flood coating.

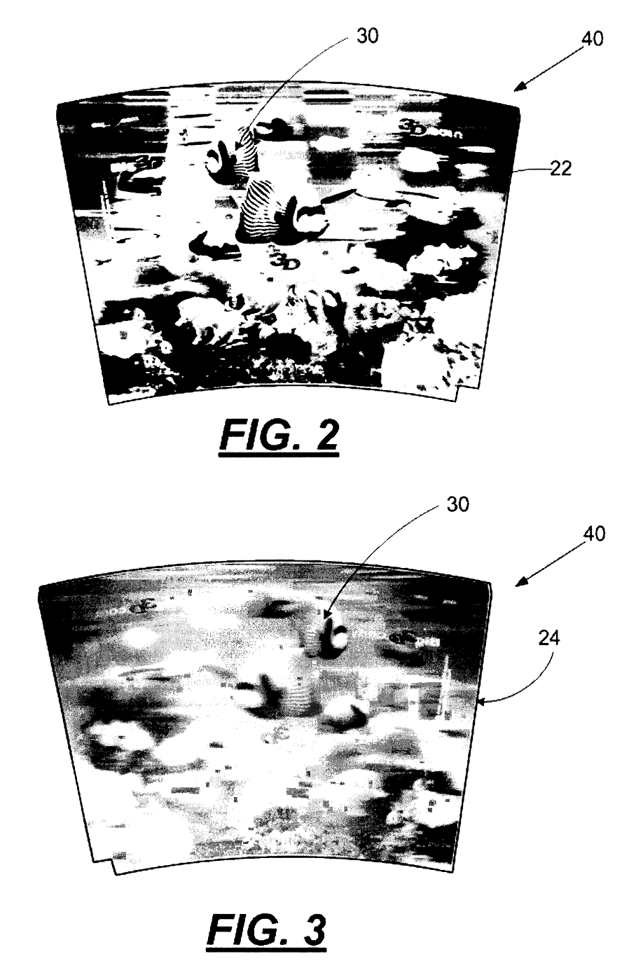

The resulting lenticular sheet 14 having the image 30 formed thereon is preferably cut to provide a blank 40 (FIGS. 2 and 3) suitable for making a cup or other container of the desired configuration. The blanks 40 may be cut from the sheets 14 by various methods, including use of conventional die cutters, such as a Bobst SP-900E available from Bobst Group USA, Inc, or in-line die-cutting if web printed.

The blanks 40 may be converted into the cups 10 or other containers as by feeding the blanks 40 into an automated machine, such as a cup forming machine available under the model names PMC 1250M or PMC 1002P from Paper Machinery Corporation of Milwaukee, Wis. The cup forming machine takes the blanks 40 and the plastic bottom members 20, and forms them into the cups 10. The seam 18 is formed by the machine by heating the overlapped ends of the blank 40, with the bottom member 20 also heat sealed to a bottom portion of the sidewall 12.

The cups 10 and other containers made in accordance with the foregoing advantageously require minimal construction components and steps to yield food-safe containers having an aesthetically pleasing lenticular display. This provides savings in both materials and manufacturing steps. The cups also have a sidewall made solely of a single plastic component and the ink applied thereto.

In an alternate embodiment, there is shown in FIG. 5 a lenticular sheet material 14′ made of a non-food safe materials. Examples of non-food safe materials include amorphous polyester teraphthalate (APET), glycol-modified polyethylene terephthalate (PETG), polyvinylchloride (PVC), and the like. The ink used to provide an image 30′ on the sheet 14′ need not be food safe, and conventional inks that are not food safe may be used, such as UV inks, UV hybrid inks, and other inks conventionally applied to lenticular sheets. The image 30′ corresponds to the image 30, except for the ink used.

To enable the material 14′ to be used to make food safe containers, a food safe material 50, such as a polypropylene food safe sheet material, is applied, as by lamination, to cover the image 30′. The material 50 preferably has a thickness of 0.003 inch. The material 14′ may then be cut to provide a blank that can be formed into a cup or other container in the manner described for the blank 40.

The material 50 may also preferably be applied to a food safe lenticular sheet, such as a polypropylene lenticular sheet, having an image printed using ink that is not food safe.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A container, comprising:
a substantially continuous container sidewall consisting essentially of a lenticular sheet having a lens side and an opposite smooth side, and an image applied directly to the smooth side of the lenticular sheet.

2. The container of claim 1, further including an opaque coating adjacent to the image opposite a lenticular sheet side of the image.

3. The container of claim 1, wherein the lenticular sheet comprises a food safe polypropylene sheet.

4. The container of claim 1, wherein the image comprises an image printed onto the smooth side using food safe ink.

5. The container of claim 1, wherein the lenticular sheet has a thickness of from about 0.008 to about 0.025 inches.

6. The container of claim 1, wherein the sidewall includes an upper edge portion rolled upon itself to define a lip.

7. A food safe cup, comprising:
a substantially continuous cup sidewall consisting essentially of a lenticular sheet made of a food safe material and having a lens side and an opposite smooth side, and an image formed of food safe ink applied directly to the smooth side of the lenticular sheet.

8. The container of claim 7, further including an opaque coating adjacent to the image and formed of food safe ink.

9. The cup of claim 7, wherein the food safe material comprises a food safe polypropylene.

10. The cup of claim 7, wherein the image comprises interlaced images.

11. The cup of claim 7, wherein the lenticular sheet has a thickness of from about 0.008 to about 0.025 inches.

12. The cup of claim 1, wherein the sidewall includes an upper edge portion rolled upon itself to define a lip.

13. The cup of claim 7, further comprising a bottom member in sealing engagement with a lower portion of the sidewall to define a cup bottom.

14. A method of making a food safe container, comprising the steps of:
providing a lenticular sheet made of a food safe material and having a lens side and an opposite smooth side;
printing an image on the smooth side of the lenticular sheet using food safe ink; and
forming the lenticular sheet into a container shape, wherein the smooth side of the lenticular sheet defines a substantially continuous interior sidewall of the container.

15. (canceled)

16. (canceled)
